(19) United States
(12) Patent Application Publication
(10) Pub. No.: US 2024/0104161 A1
(43) Pub. Date: Mar. 28, 2024

(54) FEW-SHOT CLASSIFIER EXAMPLE EXTRACTION

(71) Applicant: Microsoft Technology Licensing, LLC, Redmond, WA (US)

(72) Inventors: Daniela MASSICETI, Sydney (AU); Samyadeep BASU, College Park, MD (US); Megan Jane STANLEY, Cambridge (GB)

(21) Appl. No.: 18/065,617

(22) Filed: Dec. 13, 2022

Related U.S. Application Data
(60) Provisional application No. 63/376,384, filed on Sep. 20, 2022.

(51) Int. Cl. G06F 17/11; G06V 10/25; G06V 10/764

(52) U.S. Cl. CPC G06F 17/11; G06V 10/25; G06V 10/764

(57) ABSTRACT

In various examples there is a computer-implemented method comprising accessing a pool of examples. The method obtains a query set comprising a plurality of held out examples in a plurality of classes. For each example in the pool, the method assigns a weight to the example and initializes the weight using a default or random value. The method accesses a constrained optimization problem. The constrained optimization is solved using a projected gradient ascent or descent, the solving resulting in optimal weights resulting in an optimal performance of a few-shot classifier on the query set, where the few-shot classifier is trained using the examples from the pool weighted by the optimal weights. The method selects, using the optimal weights, an example per class from the pool, and stores the selected examples.

### CROSS-REFERENCE TO RELATED APPLICATION

This application claims the benefit of U.S. provisional application No. 63/376,384 filed on Sep. 20, 2022, entitled “Few-Shot classifier example extraction” the entirety of which is hereby incorporated by reference herein.

### BACKGROUND

Few-shot classifiers are computer-implemented functionality for assigning an item to one of a plurality of possible classes, and where the functionality has been trained with a small number of examples per class. Image classifiers which are few-shot classifiers are trained on only tens or less of images in some cases. In contrast, many-shot classifiers trained with hundreds of examples per class are widespread such as those trained using the ImageNet (trade mark) dataset. Few-shot classifiers are operable in a wide variety of types of classification task, such as image recognition, speech recognition, medical image analysis, handwriting recognition, text classification and many more.

The performance of few-shot classifiers is often found to vary as explained in more detail below.

The embodiments described below are not limited to implementations which solve any or all of the disadvantages of known technology associated with few-shot classifiers.

### SUMMARY

The following presents a simplified summary of the disclosure in order to provide a basic understanding to the reader. This summary is not intended to identify key features or essential features of the claimed subject matter nor is it intended to be used to limit the scope of the claimed subject matter. Its sole purpose is to present a selection of concepts disclosed herein in a simplified form as a prelude to the more detailed description that is presented later.

In various examples there is a computer-implemented method comprising accessing a pool of examples. The method obtains a query set comprising a plurality of held out examples in a plurality of classes. For each example in the pool, the method assigns a weight to the example and initializes the weight using a default or random value. The method accesses a constrained optimization problem. The constrained optimization is solved using a projected gradient ascent or descent, the solving resulting in optimal weights resulting in an optimal performance of a few-shot classifier on the query set, where the few-shot classifier is trained using the examples from the pool weighted by the optimal weights. The method selects, using the optimal weights, an example per class from the pool, and stores the selected examples.

The optimal performance of the few-shot classifier is a best performance or a worst performance. The stored examples are usable for a variety of purposes including but not limited to: providing metadata of a stored example to a user or an automated process, providing feedback comprising a selected example, analyzing content of a selected example to extract a characteristic of the selected example, creating a benchmark comprising a selected example, modifying the few-shot classifier so it has improved performance for a selected example, training the few-shot classifier using a support set drawn from the pool excluding a selected example, personalizing the few-shot classifier. The term “support set” is explained below.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a schematic diagram of an example extractor for use with a few-shot classifier;

FIG. 2 is a flow diagram of a method performed by an example extractor such as that of FIG. 1;

FIG. 3 is a flow diagram of a method performed by an example extractor such as that of FIG. 1;

FIG. 4 is a flow diagram of another method performed by an example extractor such as that of FIG. 1;

FIG. 5 illustrates an exemplary computing-based device in which embodiments of an example extractor are implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present examples are constructed or utilized. The description sets forth the functions of the examples and the sequence of operations for constructing and operating the examples. However, the same or equivalent functions and sequences may be accomplished by different examples.

A constrained optimization problem is a problem of finding at least one solution to a function and where the solution space is limited by at least one constraint.

Projected gradient ascent is a method to solve a constrained optimization process which searches for a local maximum of a function by moving in steps in the direction of a gradient of the function at the current point. At each step the process moves in the direction of the gradient and then projects onto a feasible set as specified by the constraint(s). Projected gradient ascent seeks to find an optimum position in the space over which optimization is performed and project in order to ensure constraints are satisfied. Projected gradient descent is analogous to projected gradient ascent except that the steps move in the direction opposite to the gradient.

A support set is at least one example for training a few-shot classifier. A query set is at least one held out example used for assessing performance of a few-shot classifier. Adaption of a few-shot classifier given a new support/training set is generally done with labelled examples. Unsupervised training with unlabeled examples is sometimes done during pre-training few-shot classifier.

Few-shot learning is the ability to learn from only a few examples, and several few-shot algorithms are currently available. The primary objective in few-shot learning is to adapt an existing trained model to any new task, where a task consists of a labeled support set (akin to a training set) and a query set (akin to a test set). The performance in few-shot learning is measured on a query set, after adaptation on the labeled support set. While few-shot classification algorithms have seen great progress, the performance of state-of-the-art few-shot classifiers can be widely different for different tasks at test time. In some cases the standard deviation of task accuracies can be large when measured over hundreds of test tasks. As a result the safety and reliability of deployed few-shot learners cannot be guaranteed.

Existing benchmarks are not set-up to disentangle the influence of data variations in a support set. Furthermore, their evaluation protocol makes no distinction between the difficulty of different tasks' support sets, instead calling for the average accuracy (and 95% confidence interval) over hundreds of randomly sampled tasks from any given dataset. As a result, these benchmarks have enabled rapid progress on learning new tasks from completely novel datasets—but are limited in how much they reveal about a model's robustness to data variations within a dataset. The latter has been largely unexplored in the few-shot literature, but is just as important for ensuring robust, deployable few-shot learners.

In various examples described herein there are processes for identifying and systematically characterizing difficult support sets for few-shot classification tasks in a principled way. Denote a task as difficult, which contains a support set which leads to the few-shot classifier performing poorly on a fixed query set. The processes described herein may also be used to identify and/or characterize easy support sets for few-shot classification tasks.

The inventors have developed a computationally efficient and general method that can extract a support set from a given search pool that causes a trained few-shot classifier to perform poorly on a fixed set of query (testing) examples when trained on these support examples. The method learns constrained selection weights associated with different examples in the pool, such that the loss on the query set is maximized. The inventors have found through empirical testing that the method is at least 20-25× faster than alternative greedy algorithms, which enables the method to be scaled to any large-scale benchmark such as META-DATASET, a previously unfeasible possibility.

The examples are any of: images, videos, speech signals, text, molecules, sensor data or other examples to be classified. The term “pool” is used to refer to a large number of examples (hundreds or thousands or more) from which a support set will be extracted.

The inventors have found that by using a projected gradient ascent it is possible to achieve a particularly efficient process which is therefore scalable to large pools of examples. Solutions not using gradient ascent (or descent) are challenging because they are more directly addressing combinatorial optimization. The gradient ascent (or descent) makes it faster and more scalable by avoiding exhaustive enumeration of all possible combinations of examples in a potential support set and comparison of their performance. Using gradient ascent (or descent) is making use of optimization machinery developed for deep learning, and in this sense is also improving the scalability.

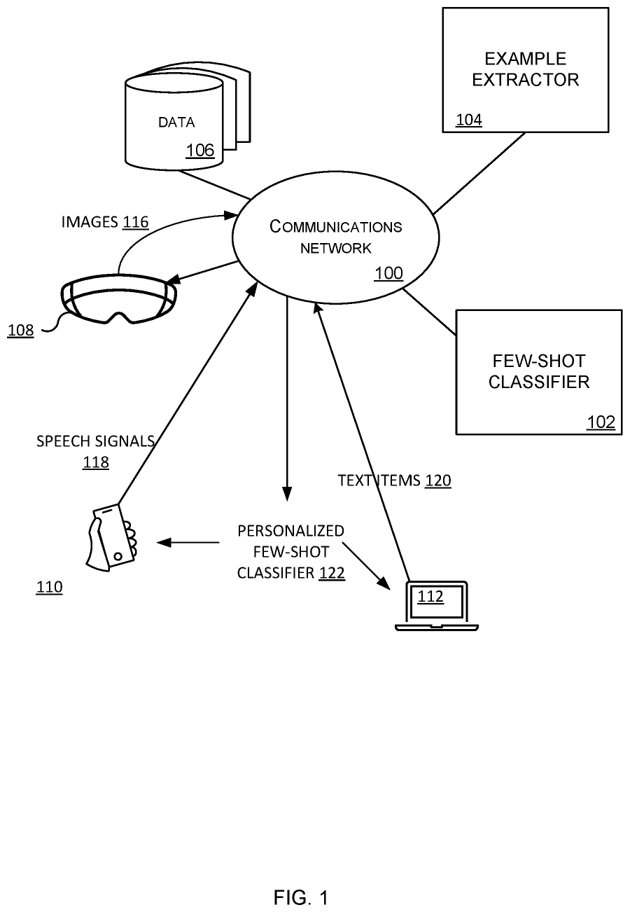

FIG. 1 is a schematic diagram of a few-shot classifier 102 connected to a communications network 100. The communications network is an intranet, extranet, the internet or any other communications network. The few-shot classifier 102 is any computer-implemented functionality for assigning an item to one of a plurality of possible classes, and where the functionality has been trained with a small number of examples per class.

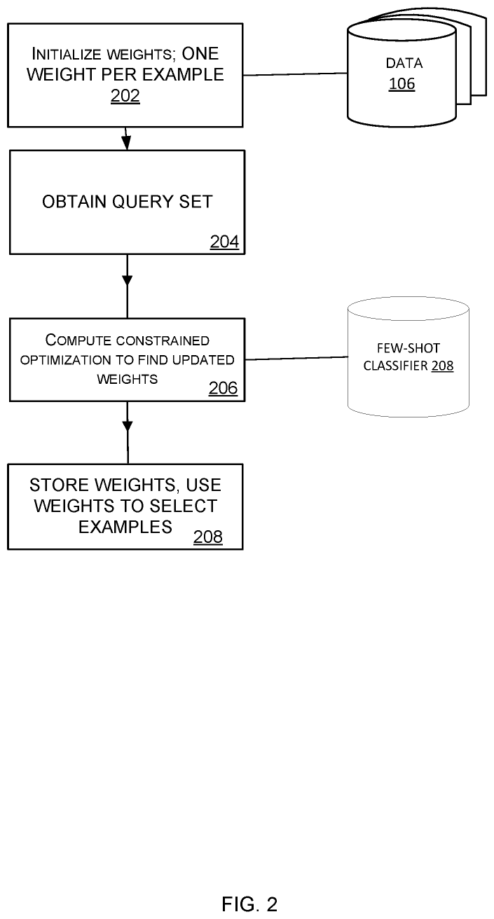

Also connected to the communications network 100 is an example extractor 104 which is computer-implemented. The example extractor 104 is able to identify at least one example per class from a pool of data 106 which will result in the few-shot classifier 102 having a worst performance or a best performance when the few-shot classifier 102 has been trained using the example. In an example, the example extractor computes weights, one weight per example, such that, each weight indicates an expected performance level of the few-shot classifier on a specified query set after having been trained using the example assigned to the weight. Each weight indicates the ‘difficulty’ of that examples for the few-shot classifier. A high weight (i.e. 1) will be a difficult example, while a low weight (i.e 0) will be an easy example. The weighted examples may be used to adapt a few-shot classifier iteratively (i.e with each iteration of the optimization algorithm) where the objective is to maximize the loss (i.e. error) on the fixed query set. Over time, the weights eventually settled on highest=difficult examples, lowest=easy examples. The example extractor may perform the methods of any of FIGS. 2 to 4.

Data 106 in one or more stores is accessible to the example extractor 104 and the few-shot classifier 102 via the communications network 100. The data comprises examples suitable for training the few-shot classifier 102 and for forming at least one query set. In some deployments the examples are images and the few-shot classifier is an image classifier. In some deployments the examples are speech signal and the few-shot classifier is a speech recognition classifier. In some deployments the examples are text and the few-shot classifier is part of a natural language classifier. In some deployments the examples are molecules and the few-shot classifier is a molecule classification apparatus. Other types of deployment are possible where the examples are of other types.

The example extractor may compute a weight for each example in a pool of examples. Using the weights at least one of the examples is selected and is usable by the example extractor 104 for a variety of useful purposes including but not limited to: providing metadata of the stored example to a user or an automated process, providing feedback comprising the selected example, analyzing content of the selected example to extract a characteristic of the selected example, creating a benchmark comprising the selected example, modifying the few-shot classifier so it has improved performance for the selected example, training the few-shot classifier using a support set drawn from the pool excluding the selected example, personalizing the few-shot classifier.

In some deployments the example extractor 104 is used to personalize the few-shot classifier 102. Three examples are now given of personalizing the few-shot classifier.

In a first example, a client device such as a head worn computer 108, captures images depicting an object in an environment of a user of the head worn computer 108. In an example, the object is a pair of spectacles of the user. The user wants the few-shot classifier to be personalized so it can recognize the object (i.e. their spectacles) in images so as to help the user find the object. Previously the few-shot classifier is able to recognize various classes of objects but not the particular spectacles of the user.

The captured images 116 are sent from the head worn computer 108 to the example extractor 104 via communications network 100. The example extractor computes a weight for each of the images as described in more detail below. Using the weights at least one of the images is selected as giving a worst performance of the few-shot classifier on a given query set when trained using the selected image. The few-shot classifier is trained using the images excluding the selected image, so that the few-shot classifier is trained more efficiently and has accurate performance at recognizing the object (such as the user's spectacles). The trained few-shot classifier is then deployed at the head worn computer 108 and used to recognize the user's spectacles and help the user locate his or her spectacles in the environment. In another example, the trained few-shot classifier is deployed in the cloud and is accessible to the head worn computer.

In a second example, a client device such as a smart phone 110, captures speech signals of a user of the smart phone. The user wants the few-shot classifier to be personalized so it can recognize speech signals of the user. Previously the few-shot classifier is able to recognize speech signals but not the particular speech signals of the user.

The captured speech signals 118 are sent from the smart phone 110 to the example extractor 104 via communications network 100. The example extractor computes a weight for each of the speech signals as described in more detail below. Using the weights at least one of the speech signals is selected as giving a worst performance of the few-shot classifier on a given query set when trained using the selected speech signal. The few-shot classifier is trained using the speech signals excluding the selected speech signal, so that the few-shot classifier is trained more efficiently and has accurate performance at recognizing that a particular user's speech is present versus other users' voices in an incoming audio signal. The trained few-shot classifier may be deployed at the smart phone or any other computing device used by the user or accessible via the cloud.

In a third example, a client device such as a desk top computer 112, receives a support set for a new task comprising a set of molecules with measured binding labels (bind or not bind) and the query set is unlabeled molecules that a computer system is to screen for their likely ability to bind. The real-world datasets in this scenario are very small so personalization of a pretrained model is very useful.

Captured text items 120 are sent from the desk top computer 112 to the example extractor 104 via communications network 100. The example extractor computes a weight for each of the text items as described in more detail below. Using the weights at least one of the text items is selected as giving a worst performance of the few-shot classifier on a given query set when trained using the selected text items. The few-shot classifier is trained using the text items excluding the selected text item, so that the few-shot classifier is trained more efficiently and has accurate performance at recognizing the user's text items. The trained few-shot classifier may be deployed at the desk top computer or any other computing device used by the user or accessible via the cloud.

The use of a constrained optimization process comprising a projected gradient ascent of the disclosure enables the example extractor to operate in an unconventional manner to achieve efficient, scalable understanding of the performance of a few-shot classifier.

By personalizing a few-shot classifier it is possible to improve the functioning of the underlying computing device to enable recognition tasks to be computed in an efficient, accurate manner.

In the example of FIG. 1 the few-shot classifier 102 and the example extractor 104 are deployed remotely from the client devices 108, 110, 112 via communications network 100. However, the functionality of the few-shot classifier 102 and the example extractor 104 may be shared between a client device and a remote computing entity. In some cases the few-shot classifier and the example extractor are deployed at an end user computing device, or at a single computing entity in communication with a client device.

Alternatively, or in addition, the functionality of the few-shot classifier and the example extractor described herein is performed, at least in part, by one or more hardware logic components. For example, and without limitation, illustrative types of hardware logic components that are optionally used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), Graphics Processing Units (GPUs).

FIG. 2 is a flow diagram of a method performed by the example extractor of FIG. 1. The example extractor has access to data 106 such as via communications network 100 in FIG. 1. In some cases the data 106 is examples sent to the example extractor by a client device.

The example extractor initializes 202 weights such that there is one weight per example and the weights are initialized to random values or default values. In an example the weights are numerical values which are zero, one or any number between zero and one.

The example extractor obtains a query set 204 which is a held out set of examples for a particular set of classes (i.e. the options the classifier is to select between). The query set 204 is obtained from the data 106 or in any other way.

The example extractor accesses a constrained optimization 206 problem which is a formulation of the problem of how to find updated weights. The constrained optimization problem is accessed from a database, memory or other store at any suitable location. The initialized weights are updated to obtain optimal weights by solving a constrained optimization problem. The example extractor uses the few-shot classifier 102 via the communications network 100. The constrained optimization is solved using projected gradient ascent or projected gradient descent. It has been found that using a projected gradient ascent (or descent) gives a particularly efficient and accurate method of computing the weights. In an example the constrained optimization process comprises a first step being a gradient ascent, and a second step being a projection step projecting a vector of the weights onto an 11 ball. Using two steps in this way is found to be particularly efficient and accurate. The inventors have recognized that by formulating the problem as a constrained optimization problem significant benefits are given. The constrained optimization may be solved using projected gradient ascent or descent (rather than, for example, “greedily” trying out all possible combinations of examples until finding a worst set of examples).

The example extractor stores 208 the updated weights and uses the weights to select at least one of the examples. In an example, the examples are ranked according to the weights and a top x number of the weights are used to select examples. In the case of projected gradient ascent, these would be the training examples the few-shot classifier finds most difficult out of the given search pool.

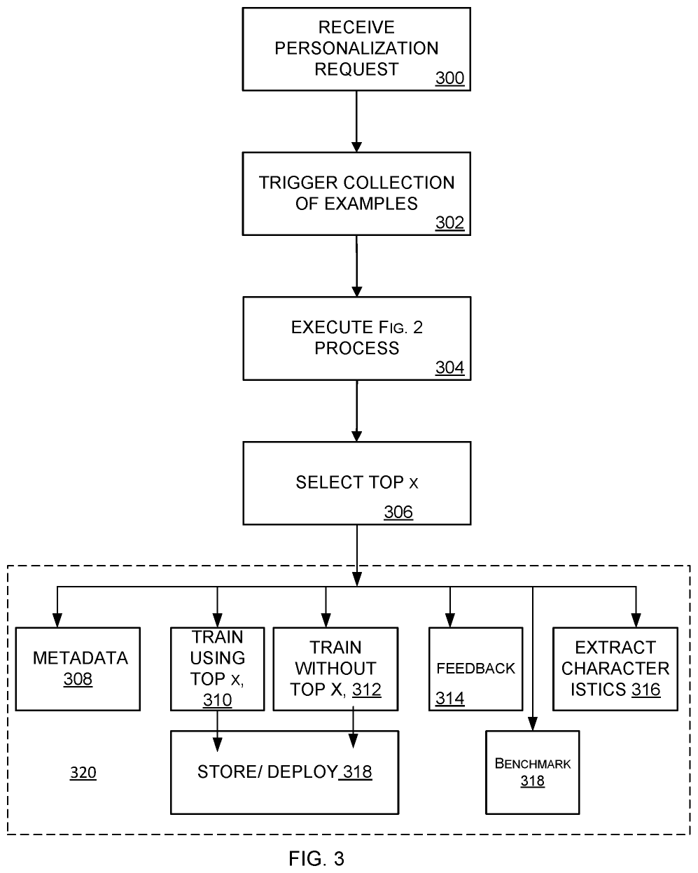

The selected examples are then used in any of the processes of item 320 of FIG. 3.

FIG. 3 is a flow diagram of another method performed by the example extractor of FIG. 1. The example extractor receives 300 a personalization request from another computing entity such as a client device or other computing entity. The personalization request is a request to adapt a few-shot classifier to operate for a new class. In an example, the personalization request is received from a user selecting an option to “train a new class” after they have collected training examples. In another example, the personalization request is received from a client device such as any of the client devices of FIG. 1.

The example extractor triggers 302 collection of examples in the new class. In an example, the example extractor triggers a client device to display a message prompting a user to capture examples in the new class. In another example, the example extractor triggers software on a client device to capture examples in the new class.

The process of FIG. 2 is then executed (see box 304 of FIG. 3) in order to compute weights of the examples. A top x number of the of examples is selected 306 according to the weights. In an example the top x examples are the examples leading to a worst performance of the few-shot classifier. In another example the bottom x examples are the examples leading to best performance of the few-shot classifier. In some cases the top x examples are at least one example.

In some cases the example extractor accesses metadata 308 about content of the selected example and provides the metadata to a user or an automated process. In this way the user or automated process is able to understand how to collect better examples for training the few-shot classifier and gains an understanding of performance of the few-shot classifier.

In some cases, the example extractor sends feedback 314 to a user via a user interface, the feedback comprising the selected example, such that the user is able to view the selected example. The user is able to visually inspect or listen to the selected example in order to gain an understanding of performance of the few-shot classifier.

In some cases, the example extractor sends feedback 314 to a computer-implemented process, the feedback comprising the selected example, such that the computer-implemented process is able to use information about the selected example to influence downstream processing.

In some cases, the example extractor analyzes content of the selected example to extract 316 a characteristic of the selected example.

In some cases, the example extractor creates a benchmark 322 comprising the selected example. In an example the benchmark is composed of the most difficult tasks for a few-shot classification to promote further work/research to develop better few-shot classifiers.

In cases where the optimal performance is a worst performance the method may comprise modifying 310 the training data used to adapt the few-shot classifier so it has improved performance for the selected example. The few-shot classifier is then stored and/or deployed 318.

In some cases the optimal performance is a worst performance and the method comprises removing the selected example from the pool and then using the training data to adapt the few-shot classifier using a support set drawn from the pool (training without top x 312). The few-shot classifier is then stored and/or deployed 318.

A detailed example of computing the constrained optimization is now given. Given a dataset D which contains examples of C object classes , first sample N unique classes from the C classes and construct a query set Q. Here Q={xᵣ, yᵣ}ᵣ₌₁^{N×q} where x is the input image, y is the class label, and q is the number of examples sampled per class. Let D′⊂D denote a sub-dataset containing examples from only the N sampled classes and let P=D′−Q denote the set of examples from D′ without the query set Q. Allowing P to be the search pool from which the difficult support set will be extracted, the goal of the extraction algorithm is to find a support set S⊂D such that the loss on the query set Q is maximized after the base model ƒ_{θ} has been adapted on S. To this end, assume selection weights w∈ [symbol] ^{M}, where wⁱ is associated with the ith example in P and M=|P| denotes the cardinality of P. The optimization objective is to learn the selection weights w which result in a maximal loss for query set Q with a sparsity constraint on the weights. Formally, maximize the following objective:

$$\begin{matrix}max \\ w\end{matrix} {\sum }_{r = 1}^{N \times q} ℓ ( ( {x}_{r} , {y}_{r} ) , P , w , {f}_{θ} ) \qquad ( 1 )$$

$$s . t . {w}^{i} ∈ \{ 0 , 1 \} , \qquad {∀}_{i} ∈ [ 1 , M ]$$

$${‖ {w}_{j} ‖}_{0} \leq {k}_{j} \qquad {∀}_{j} ∈ [ 1 , N ]$$

Where ƒ_{θ} is the base model trained with either meta-learning or supervised learning, [symbol] is the loss after adapting ƒ_{θ} on P where each of its examples are weighted by w, and wⱼ is the selection weight vector corresponding to the jth class. Here w=w₁⊕w₂⊕ . . . ⊕w_{N} and denote wⱼⁱ as the selection weight for the ith example in the weight vector wⱼ for the jth class. Note w are the only learnable parameters. The optimization constraints ensure that each selection weight is either 0 or 1, and that a maximum of kⱼ examples are selected from P for each jth class.

Different approaches can be used to adapt ƒ_{θ}. In an example, use the adaptation strategy of prototypical networks whereby a mean embedding is computed for each class, with the loss based on a Euclidean distance between a query image embedding to each of the class prototypes. Using the adaptation strategy of prototypical networks is found to be highly efficient and has no learnable parameters. Other adaptations strategies such as fine-tuning may be used in deployments where computational costs may be increased.

Solve equation (1) in two steps. First take 1 gradient ascent step on the selection weights w to obtain ŵ. Second, project the selection weight vector of each class ŵⱼ to the [symbol] ₒ norm ball to obtain the final selection weights w̅ⱼ. In practice, the second step is difficult to solve as it is NP-hard and the [symbol] ₒ constraint is non-convex. Therefore, relax the [symbol] ₒ norm to an [symbol] ₁ norm to make the constraint convex and enable easier computation. The projection step with [symbol] ₁ relaxation for the jth class is formalized as follows:

$$\begin{matrix}min \\ {w}_{j}\end{matrix} \frac{1}{2} ‖ {w}_{j} - {\hat{w}}_{j} ‖ \begin{matrix}2 \\ 2\end{matrix} \qquad ( 2 )$$

$$s . t . {‖ {w}_{j} ‖}_{1} \leq {k}_{j}$$

Solve the dual form of the above projection step via Lagrange multipliers to obtain the optimal sparse weight vector w̅ⱼ:

$${\overline{w}}_{j} = {argmax}_{{λ}_{j} \geq 0} {min}_{{w}_{j}} {\underbrace{\frac{1}{2} ‖ {w}_{j} - {\hat{w}}_{j} ‖ \begin{matrix}2 \\ 2\end{matrix} + {λ}_{j} ( {‖ {w}_{j} ‖}_{1} - {k}_{j} )}}_{ℊ ( {λ}_{j} , {w}_{j} )} \qquad ( 3 )$$

Where λⱼ is the Lagrange multiplier corresponding to the projection step for the jth class. In practice, solve the projection step per class to ensure at least a few examples per class are selected.

In practice, it is found that one projection step per class is sufficient to learn appropriate selection weights. Thus the method is able to extract difficult support sets after only one projection step, thus making it fast. The speedup comes from the whole way the formulation is set-up, and is further enhanced where only 1 projection step is used. Once the class weight vectors have been learned, the next step is to select the hardest support examples to construct the difficult support set. For each jth class, sort the final selection weight vector wⱼ in descending order and extract the kⱼ examples from P which have the highest weights.

Details are now given of one example of how to solve the projection step in Equation (3). The projection step is solved separately for each of the j^{th} class, where j∈[1, N]. ŵⱼ is the selection weight vector for the j^{th} class obtained after a step of gradient ascent on Equation (1). The dual form of Equation (2) can be expressed via Lagrange multipliers as the following:

$${\overline{w}}_{j} = \begin{matrix}arg max \\ {λ}_{j} \geq 0\end{matrix} \begin{matrix}min \\ {w}_{j}\end{matrix} {\underbrace{\frac{1}{2} ‖ {w}_{j} - {\hat{w}}_{j} ‖ \begin{matrix}2 \\ 2\end{matrix} + {λ}_{j} ( {‖ {w}_{j} ‖}_{1} - {k}_{j} )}}_{ℊ ( {λ}_{j} , {w}_{j} )} \qquad ( 4 )$$

Solve Equation (4) in two steps: (i) First, solve min_{w}_{ⱼ}g(λⱼ, wⱼ) via proximal operators; (ii) Then, obtain the optimal values of the dual parameters λⱼ.

KKT optimality conditions (due to stationarity) states that ∇_{w}_{ⱼ}g(λⱼ, wⱼ)=0. However, note that g(λⱼ, wⱼ) is a combination of a smooth function and a non-smooth function which can be solved by proximal operators. Considering wⱼ∈ [symbol] ⁿ, the KKT optimality condition can be stated as the following:

∇_{w}_{ⱼ}½∥wⱼ−ŵⱼ∥²+∇_{w}_{ⱼ}λⱼ(∥wⱼ∥₁−kⱼ)=0 (5)

The value in the ith index in wⱼ, which is wⱼⁱ can be obtained through:

$$\frac{1}{2} \frac{\partial {( {w}_{j}^{i} - {\hat{w}}_{j}^{i} )}^{2}}{\partial {w}_{j}^{i}} + {λ}_{j} \frac{\partial \vert {w}_{j}^{i} \vert}{\partial {w}_{j}^{i}} = 0 \qquad ( 6 )$$

If wⱼⁱ>0, then the derivative in Equation (6) is wⱼⁱ−ŵⱼⁱ+λⱼ. Therefore Equation (6) can be expressed as: w̅ⱼⁱ=ŵⱼⁱ−λⱼ, which holds true for ŵⱼⁱ>λⱼ. Similarly, when wⱼⁱ<0, w̅ⱼⁱ=ŵⱼⁱ+λⱼ is the minimizer. For ŵⱼⁱ∈[−λⱼ, λⱼ], the minimizer is at the only point of differentiability for which wⱼⁱ=0. This operation is called soft-thresholding and can be expressed as:

w̅ⱼⁱ=Prox_{λ*}∥·∥₁(ŵⱼⁱ)=sign(ŵⱼⁱ)max(|ŵⱼⁱ|−λ*ⱼ, 0) (7)

Thus, w̅ⱼ=Prox_{λ*}∥·∥₁(ŵⱼ)=[Prox_{λ*}∥·∥₁(ŵⱼ¹), . . . , Prox_{λ*}∥·∥₁(ŵⱼⁿ)]. The next step is to compute the value of the dual parameter λ*ⱼ. Then compute the derivative g′(λⱼ, ŵⱼ) as the following:

g′(λⱼ, w̅ⱼ)=∥Prox_{λ*∥·∥}_{₁}(ŵⱼ) ∥₁−kⱼ (8)

=Σᵢ₌₁ⁿ(|ŵⱼⁱ|−λⱼ)₊−kⱼ (9)

In an example, solve Equation (9) by the root finding method since the optimal λ*ⱼ∈[0, ∥ŵⱼ∥_{∞}]. The upper bound ∥ŵⱼ∥_{∞} ensures that g′(λⱼ, w̅ⱼ) does not become negative.

In experiments this projection technique is found to work well across a wide range of datasets in terms of both speed and accuracy. The proposed support set extraction algorithm is 20-30× faster than a greedy approach. Moreover, for a wide-variety of query sets across a range of complex datasets, the method described above is able to extract worst case support sets which result in a much larger drop in query accuracy than a greedy method.

For the learning rate α, perform a grid search from 0.01 to 100 in multiples of 10. In practice, it is found that running the gradient ascent step only once with a high learning rate (greater than 1) works the best. It is found that setting α=20, leads to the most difficult tasks. For extracting 5-way-5-shot tasks in an example set Kₘₐₓ=10, whereas for 5-way-1-shot tasks, set Kₘₐₓ=5. For either of the configurations, sort the final weight vector w* in descending order and extract the first 5 examples for 5-shot tasks and the first example for 1-shot tasks. The projection step per class is run only once after the gradient ascent step to obtain the final sparse weight vector. ‘Way’ is the number of classes to distinguish between in the task. “Shot” is the number of training examples per class given to the classifier to adapt.

Another example method of computing the constrained optimization of FIG. 2 is expressed using pseudo code as follows:

Require: Q: task query set; N: number of classes (ways), P: search pool for extracting task support set; ƒ_{θ}: feature-extractor; M: size of search pool; {kⱼ}ⱼ₌₁^{N}: set containing the maximum number of examples that can be selected per class; α: learning rate.

| | |
|---|---|
| w ← CONCAT(wⱼ) ∀ⱼ ϵ [1, N] | Concatenate initialized vectors for each class |
| for j in N do | |
| cⱼ ← Σᵢ₌₁^{\|Pj\|}wⱼⁱf_{θ}(xⱼ)/Σᵢ₌₁^{\|Pj\|}wⱼⁱ | [symbol] Compute weighted class prototypes |
| end for | |
| c ← [c₁, ... , c_{N}] | [symbol] Store the weighted prototypes for each class |
| L ← PROTO − LOSS(Q, c, f_{θ}) | [symbol] Compute prototypical loss |
| L. BACKWARD(w) | [symbol] Compute gradients with respect to selection weights |
| w ← w + α∇_{w}L(w) | [symbol] Gradient ascent for updating weights |
| for j in N do | |
| wⱼ ← PROJ(wⱼ, kⱼ) | [symbol] Projection step per class |
| end for | |
| for j in N do | |
| sⱼ ← EXTRACT(kⱼ, wⱼ, P) | [symbol] Extract kⱼ examples with the highest weights |
| end for | |
| S ← CONCAT(sⱼ) ∀ⱼ ϵ [1, N] | [symbol] Obtain the final difficult support set S |

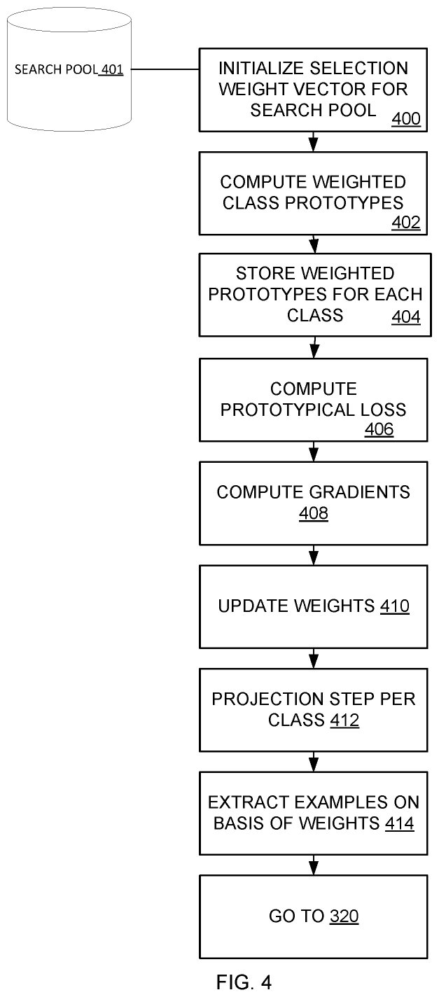

The above pseudo code is now explained with reference to FIG. 4.

FIG. 4 is a flow diagram of an example method of computing the constrained optimization of FIG. 2. The first line of the pseudo code represents instructions to initialize 400 a selection weight vector for a search pool 401 which is a plurality of examples suitable for training a few-shot classifier. Each example in the search pool has an associated weight and the weight vector per class is concatenated (as denoted in the second line of the pseudo code) into a weight vector. In an example, store a weight vector per class (i.e. equal to the number of examples in the pool that have the label for that class). These class vectors are concatenated together to get one overall weight vector for the whole pool. The values of the weights are set to random initial values.

For each of a number of ways N of the few-shot classifier a weighted class prototype c is computed 402 as indicated in the first for loop of the pseudo code. For a way i of the few-shot classifier the weighted class prototype c is given by the sum over classes of the weighted outputs of the few-shot classifier divided by the sum over classes of the weights. A class prototype is the mean example feature extracted by a feature extractor of the few-shot classifier.

The weighted class prototypes are stored 404 for each class. A prototypical loss L is computed 406 using the query set Q, weighted class prototype c, and few shot classifier. Prototypical Networks compute the Euclidean distance between a feature of a new test example and each mean class feature (i.e. the prototype). This gives a vector of logits (of length=number of classes) where each number in the vector represents the likelihood of the test example belonging to that class. This logit vector is then used, in combination with the ground truth label of that test example, to compute the cross entropy loss which is used as the objective of the optimization described herein. Note, the loss can be the sum/mean over multiple test examples.

Gradients are computed 408 with respect to the selection weights as indicated in the pseudo code and then gradient ascent is used for updating 410 the weights.

One projection step per class is computed 412.

Examples are extracted from the search pool 401 on the basis of the weights 414 and the extracted examples are optionally concatenated to form a final difficult (or easy) support set S.

Any one or more of the methods of operation 320 are optionally followed using the example(s) extracted from the search pool on the basis of the weights.

The method of FIG. 4 is workable to find either examples which give a worst performance of the few-shot classifier or examples which give a best performance of the few-shot classifier. Where the process uses gradient ascent (i.e. w=w+ . . . ), it is trying to maximize the loss. This means the process will return the hardest examples—i.e. the examples that led to the highest loss. If gradient descent is used (i.e. w=w− . . . ), then the process returns the easiest examples—i.e. the examples that led to the lowest loss.

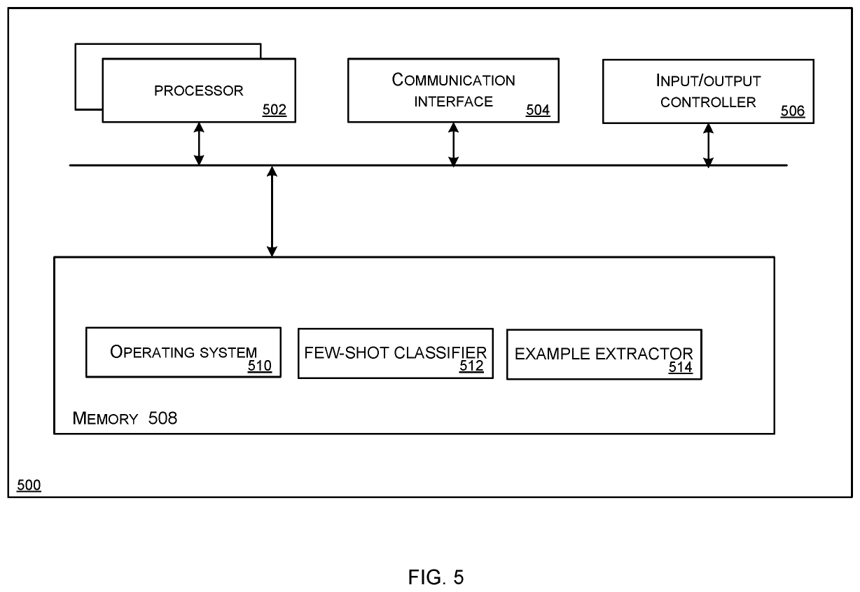

FIG. 5 illustrates various components of an exemplary computing-based device 500 which are implemented as any form of a computing and/or electronic device, and in which embodiments of a few-shot classifier and/or example extractor 514 are implemented in some examples.

Computing-based device 500 comprises one or more processors 502 which are microprocessors, controllers or any other suitable type of processors for processing computer executable instructions to control the operation of the device in order to select examples likely to lead to poor performance of a few-shot classifier when used to train the few-shot classifier. In some examples, for example where a system on a chip architecture is used, the processors 502 include one or more fixed function blocks (also referred to as accelerators) which implement a part of the method of any of FIGS. 2 to 4 in hardware (rather than software or firmware). A few-shot classifier 512 is implemented at the computing-based device 500 as is an example extractor 514 such as the example extractor of FIG. 2. Platform software comprising an operating system 510 or any other suitable platform software is provided at the computing-based device to enable application software to be executed on the device.

The computer executable instructions are provided using any computer-readable media that is accessible by computing based device 500. Computer-readable media includes, for example, computer storage media such as memory 508 and communications media. Computer storage media, such as memory 508, includes volatile and non-volatile, removable and non-removable media implemented in any method or technology for storage of information such as computer readable instructions, data structures, program modules or the like. Computer storage media includes, but is not limited to, random access memory (RAM), read only memory (ROM), erasable programmable read only memory (EPROM), electronic erasable programmable read only memory (EEPROM), flash memory or other memory technology, compact disc read only memory (CD-ROM), digital versatile disks (DVD) or other optical storage, magnetic cassettes, magnetic tape, magnetic disk storage or other magnetic storage devices, or any other non-transmission medium that is used to store information for access by a computing device. In contrast, communication media embody computer readable instructions, data structures, program modules, or the like in a modulated data signal, such as a carrier wave, or other transport mechanism. As defined herein, computer storage media does not include communication media. Therefore, a computer storage medium should not be interpreted to be a propagating signal per se. Although the computer storage media (memory 508) is shown within the computing-based device 500 it will be appreciated that the storage is, in some examples, distributed or located remotely and accessed via a network or other communication link (e.g. using communication interface 504).

The computing-based device 500 also comprises an input/output controller 506 arranged to output display information to a display device which may be separate from or integral to the computing-based device 500. The display information may provide a graphical user interface to display extracted examples. The input/output controller 506 is also arranged to receive and process input from one or more devices, such as a user input device (e.g. a mouse, keyboard, camera, microphone or other sensor). In some examples the user input device receives input from a camera or microphone to capture examples.

Alternatively or in addition to the other examples described herein, examples include any combination of the following:

Clause A. A computer-implemented method comprising:
accessing a pool of examples;
obtaining a query set comprising a plurality of held out examples in a plurality of classes;
for each example in the pool, assigning a weight to the example and initializing the weight using a default or random value,
formulating a constrained optimization problem;
solving the constrained optimization problem using a projected gradient ascent or descent, the solving resulting in optimal weights resulting in an optimal performance of a few-shot classifier on the query set, where the few-shot classifier is trained using the examples from the pool weighted by the optimal weights;
selecting, using the optimal weights, an example per class from the pool;
storing the selected examples.

Clause B. The computer-implemented method of clause A further comprising, for one of the selected examples, accessing metadata about content of the selected example and providing the metadata to a user or an automated process.

Clause C. The computer-implemented method of clause A or clause B further comprising providing feedback to a user via a user interface, the feedback comprising one of the selected examples, such that the user is able to view the selected example.

Clause D. The computer-implemented method of any preceding clause further comprising providing feedback to a computer-implemented process, the feedback comprising one of the selected examples, such that the computer-implemented process is able to use information about the selected example to influence downstream processing.

Clause E. The computer-implemented method of any preceding clause further comprising analyzing content of one of the selected examples to extract a characteristic of the selected example.

Clause F. The computer-implemented method of any preceding clause further comprising creating a benchmark comprising one of the selected examples.

Clause G. The computer-implemented method of any preceding clause where the optimal performance is a worst performance and wherein the method comprises modifying the few-shot classifier so it has improved performance for one of the selected examples.

Clause H. The computer-implemented method of any preceding clause where the optimal performance is a worst performance and wherein the method comprises removing one of the selected examples from the pool and then training the few-shot classifier using a support set drawn from the pool.

Clause I. The method of any preceding clause wherein the constrained optimization problem is constrained using a sparsity constraint on the weights.

Clause J. The method of any preceding clause wherein the constrained optimization problem comprises a first step being a gradient ascent, and a second step being a projection step projecting a vector of the weights onto an 11 ball.

Clause K. The method of clause J wherein only one projection step is used per class.

Clause L. The method of clause J or clause K wherein the gradient ascent uses a high learning rate.

Clause M. The method of any of clauses J to L wherein the projection step is computed using a Lagrange multiplier computed to obtain a vector of the optimal weights by setting the vector of the optimal weights equal to a sign of the weight vector multiplied by the magnitude of the weight vector minus a constant.

Clause N. The method of any preceding clause wherein the examples are any of: images, videos, speech signals, text, molecules, sensor data.

Clause O. An apparatus comprising:
a processor (502);
a memory (508) storing instructions that, when executed by the processor (502), perform a method comprising:
accessing a pool of examples of a new class, the examples being associated with a user;
obtaining a query set comprising a plurality of held out examples of the new class;
for each example in the pool, assigning a weight to the example and initializing the weight using a default or random value,
accessing a constrained optimization problem;
solving the constrained optimization problem using a projected gradient ascent or descent, the solving resulting in optimal weights resulting in an optimal performance of a few-shot classifier on the query set, where the few-shot classifier is trained using the examples from the pool weighted by the optimal weights;
selecting, using the optimal weights, an example per class from the pool;
adapting the few-shot classifier using the pool excluding the selected examples, to create an adapted few-shot classifier, such that the adapted few-shot classifier is able operate for the new class.

Clause P. The apparatus of clause O wherein the few-shot classifier operates for the new class in addition to at least one other class.

Clause Q. The apparatus of clause O or clause P wherein the pool of examples are images depicting an object of interest to the user and wherein the adapted few-shot classifier is operable to recognize the object of interest in images depicting an environment of the user in order to help the user locate the object of interest.

Clause R. A computer storage medium having computer-executable instructions that, when executed by a computing system, direct the computing system to perform operations comprising:
accessing a pool of images;
obtaining a query set comprising a plurality of held out images;
for each image in the pool, assigning a weight to the image and initializing the weight using a default or random value,
accessing a constrained optimization problem;
solving the constrained optimization problem using a projected gradient ascent or descent, the solving resulting in optimal weights resulting in an optimal performance of a few-shot classifier on the query set, where the few-shot classifier is trained using the images from the pool weighted by the optimal weights;
selecting, using the optimal weights, an image per class from the pool;
storing the selected images.

Clause S. The computer storage medium of clause R wherein the images depict an object of a class not yet operable by the few-shot classifier.

Clause T. The computer storage medium of clause R or clause S wherein the operations comprise adapting the few-shot classifier using images from the pool excluding the selected images.

The term ‘computer’ or ‘computing-based device’ is used herein to refer to any device with processing capability such that it executes instructions. Those skilled in the art will realize that such processing capabilities are incorporated into many different devices and therefore the terms ‘computer’ and ‘computing-based device’ each include personal computers (PCs), servers, mobile telephones (including smart phones), tablet computers, set-top boxes, media players, games consoles, personal digital assistants, wearable computers, and many other devices.

The methods described herein are performed, in some examples, by software in machine readable form on a tangible storage medium e.g. in the form of a computer program comprising computer program code means adapted to perform all the operations of one or more of the methods described herein when the program is run on a computer and where the computer program may be embodied on a computer readable medium. The software is suitable for execution on a parallel processor or a serial processor such that the method operations may be carried out in any suitable order, or simultaneously.

Those skilled in the art will realize that storage devices utilized to store program instructions are optionally distributed across a network. For example, a remote computer is able to store an example of the process described as software. A local or terminal computer is able to access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The operations of the methods described herein may be carried out in any suitable order, or simultaneously where appropriate. Additionally, individual blocks may be deleted from any of the methods without departing from the scope of the subject matter described herein. Aspects of any of the examples described above may be combined with aspects of any of the other examples described to form further examples without losing the effect sought.

The term ‘comprising’ is used herein to mean including the method blocks or elements identified, but that such blocks or elements do not comprise an exclusive list and a method or apparatus may contain additional blocks or elements.

The term ‘subset’ is used herein to refer to a proper subset such that a subset of a set does not comprise all the elements of the set (i.e. at least one of the elements of the set is missing from the subset).

It will be understood that the above description is given by way of example only and that various modifications may be made by those skilled in the art. The above specification, examples and data provide a complete description of the structure and use of exemplary embodiments. Although various embodiments have been described above with a certain degree of particularity, or with reference to one or more individual embodiments, those skilled in the art could make numerous alterations to the disclosed embodiments without departing from the scope of this specification.

1. A computer-implemented method comprising:
accessing a pool of examples;
obtaining a query set comprising a plurality of held out examples in a plurality of classes;
for each example in the pool, assigning a weight to the example and initializing the weight using a default or random value,
accessing a constrained optimization problem;
solving the constrained optimization problem using a projected gradient ascent or descent, the solving resulting in optimal weights resulting in an optimal performance of a few-shot classifier on the query set, wherein the few-shot classifier is trained using the examples from the pool weighted by the optimal weights;
selecting, using the optimal weights, an example per class from the pool;
storing the selected examples.

2. The computer-implemented method of claim 1 further comprising, for one of the selected examples, accessing metadata about content of the selected example and providing the metadata to a user or an automated process.

3. The computer-implemented method of claim 1 further comprising providing feedback to a user via a user interface, the feedback comprising one of the selected examples, such that the user is able to view the selected example.

4. The computer-implemented method of claim 1 further comprising providing feedback to a computer-implemented process, the feedback comprising one of the selected examples, such that the computer-implemented process is able to use information about the selected example to influence downstream processing.

5. The computer-implemented method of claim 1 further comprising analyzing content of one of the selected examples to extract a characteristic of the selected example.

6. The computer-implemented method of claim 1 further comprising creating a benchmark comprising one of the selected examples.

7. The computer-implemented method of claim 1 where the optimal performance is a worst performance and wherein the method comprises modifying the few-shot classifier so it has improved performance for one of the selected examples.

8. The computer-implemented method of claim 1 where the optimal performance is a worst performance and wherein the method comprises removing one of the selected examples from the pool and then training the few-shot classifier using a support set drawn from the pool.

9. The computer-implemented method of claim 1 wherein the constrained optimization problem is constrained using a sparsity constraint on the weights.

10. The computer-implemented method of claim 1 wherein the constrained optimization problem comprises a first step being a gradient ascent, and a second step being a projection step projecting a vector of the weights onto an 11 ball.

11. The computer-implemented method of claim 10 wherein only one projection step is used per class.

12. The computer-implemented method of claim 10 wherein the gradient ascent uses a high learning rate.

13. The computer-implemented method of claim 10 wherein the projection step is computed using a Lagrange multiplier computed to obtain a vector of the optimal weights by setting the vector of the optimal weights equal to a sign of the weight vector multiplied by the magnitude of the weight vector minus a constant.

14. The computer-implemented method of claim 1 wherein the examples are any of: images, videos, speech signals, text, molecules, sensor data.

15. An apparatus comprising:
a processor (502);
a memory (508) storing instructions that, when executed by the processor (502), perform a method comprising:
accessing a pool of examples of a new class, the examples being associated with a user;
obtaining a query set comprising a plurality of held out examples of the new class;
for each example in the pool, assigning a weight to the example and initializing the weight using a default or random value,
accessing a constrained optimization problem;
solving the constrained optimization problem using a projected gradient ascent or descent, the solving resulting in optimal weights resulting in an optimal performance of a few-shot classifier on the query set, where the few-shot classifier is trained using the examples from the pool weighted by the optimal weights;
selecting, using the optimal weights, an example per class from the pool;
adapting the few-shot classifier using the pool excluding the selected examples, to create an adapted few-shot classifier, such that the adapted few-shot classifier is able operate for the new class.

16. The apparatus of claim 15 wherein the few-shot classifier operates for the new class in addition to at least one other class.

17. The apparatus of claim 15 wherein the pool of examples are images depicting an object of interest to the user and wherein the adapted few-shot classifier is operable to recognize the object of interest in images depicting an environment of the user in order to help the user locate the object of interest.

18. A computer storage medium having computer-executable instructions that, when executed by a computing system, direct the computing system to perform operations comprising:
accessing a pool of images;
obtaining a query set comprising a plurality of held out images;
for each image in the pool, assigning a weight to the image and initializing the weight using a default or random value,
accessing a constrained optimization problem;
solving the constrained optimization problem using a projected gradient ascent or descent, the solving resulting in optimal weights resulting in an optimal performance of a few-shot classifier on the query set, where the few-shot classifier is trained using the images from the pool weighted by the optimal weights;
selecting, using the optimal weights, an image per class from the pool;
storing the selected images.

19. The computer storage medium of claim 18 wherein the images depict an object of a class not yet operable by the few-shot classifier.

20. The computer storage medium of claim 19 wherein the operations comprise adapting the few-shot classifier using images from the pool excluding the selected images.
